(19) United States
(12) Patent Application Publication
(10) Pub. No.: US 2006/0088453 A1
(43) Pub. Date: Apr. 27, 2006

(54) Directly cooled ozone generator

(76) Inventor: Ernst-Martin Billing, ENGER (DE)

Correspondence Address: ROBERT W. BECKER & ASSOCIATES, 707 HIGHWAY 66 EAST, SUITE B, TIJERAS, NM, 87059, US

(21) Appl. No.: 10/535,519

(22) PCT Filed: Nov. 18, 2003
(86) PCT No.: PCT/EP03/12892

§ 371 Date: Aug. 16, 2005

(30) Foreign Application Priority Data
Nov. 19, 2002 (DE) 102 54 049.7

(51) Int. Cl. B01J 19/08

(52) U.S. Cl. 422/186.2; 422/186.07

(57) ABSTRACT

An ozone generator comprising a number of steel components, including hollow cathode tubes, tubesheets, and a shell, wherein the hollow cathode tubes are disposed between two oppositely disposed tubesheets, wherein each hollow cathode tube delimits an inner space through which gas my flow, wherein the hollow cathode tubes delimit a shell space that may be subiected to coolant, and wherein the steel components are made, at least in part, of a steel having a nickel content of less than 10% by weight and/or a molybdenum content of less than 2% by weight. A cooling unit is Provided for cooling and includes an evaporator, compressor and condenser, wherein the evaporator is incorporated directly into the shell of the ozone separator

The present invention relates to an ozone generator having the features of the pre-characterizing clause of claim 1.

Ozone generators of the above type are known from the prior art, for example from WO97/09268. They comprise a plurality of hollow cathode tubes, which are arranged parallel to one another between two tubesheets in the manner of a shell and tube heat exchanger. The tubes form in their interior spaces discharge chambers in the form of hollow cathodes. Anode rods with dielectric are arranged in these discharge chambers, to which rods a high voltage is applied during operation and which bring about corona discharge between the anode rod and the tube. Oxygen-containing gas or pure oxygen is passed through this space. The corona discharge produces ozone molecules in the oxygen-containing gas from oxygen molecules. The gas stream ozonized in this way may then be used for example for disinfection purposes or for chlorine-free bleaching.

With this type of ozone production, only around 10% to 15% of the electrical power which has to be supplied to an ozone generator is utilized for ozone production. 85% to 90% of the electrical power supplied is dissipated as waste heat, this dissipation taking place in the shell space surrounding the outsides of the tubes by means of cooling water which is passed along between the tubesheets. This cooling water heats up accordingly as it passes through the tube bundle and is cooled to a temperature of only a few ° C. as it circulates through a further heat exchanger in a cooling unit.

Ozone generation efficiency depends greatly on the temperature of the tubes. One mechanism which impairs the efficiency of an ozone generator is the partial heating of the hollow cathodes in areas where hot spots form and the temperature gradient which inevitably arises along the tubes between the cooling water inlet and the cooling water outlet. The ozone-containing gas flowing through the interior of the hollow cathodes in this area undergoes ozone decomposition due to the higher temperature, which decomposition reduces the actual content of usable ozone in the gas stream produced. This temperature-induced ozone degradation reduces the overall efficiency of the ozone generator.

In the closest prior art, documented in European Patent Application EP 0 121 235 A1, it is therefore proposed to achieve the smallest possible temperature gradient inside the ozone generator in that the ozone generator is directly cooled with a boiling refrigerant. Because, in the case of this known ozone generator, the evaporator of the cooling unit is incorporated directly into the shell of the ozone generator and a cooling water circuit is omitted, the entire tube bundle is substantially at the evaporation temperature of the refrigerant. Temperature gradients inside the tube bundle are virtually eliminated. However, the prior art does not propose any materials which differ from the materials known from the construction of water-cooled ozone generators. These are high-alloy special steels, for example those known as 1.4571, corresponding to X6bCrNiMoTi17-12-2 with a nickel content of 12 wt. % and a molybdenum content of 2 wt. %, or as 1.4404 in the area of the hollow cathodes and the tubesheets due to the additional ozone resistance.

Taking this prior art as basis, it is the object of the present invention to provide a directly cooled ozone generator which is further improved with regard to efficiency and manufacturing costs.

This object is achieved with an ozone generator having the features of claim 1.

Reliable operation is ensured even with low-boiling coolant if the interior space and shell space exhibit a pressure resistance of at least 16 bar. In particular the coolant may be 1,1,1,2-tetrafluoroethane (CF₃—CH₂F).

Advantages with regard to operating reliability are also achieved if an aerosol separator is provided between the shell space and the compressor.

Control of the pressure in the shell space may be provided in particular in that the pressure above the boiling coolant is so adjusted as to set a boiling point of less than 6° C. and in particular less than 5° C. It may be advantageous to select a boiling point of below 0° C.

Exemplary embodiments of the present invention are described below with reference to the drawings, in which:

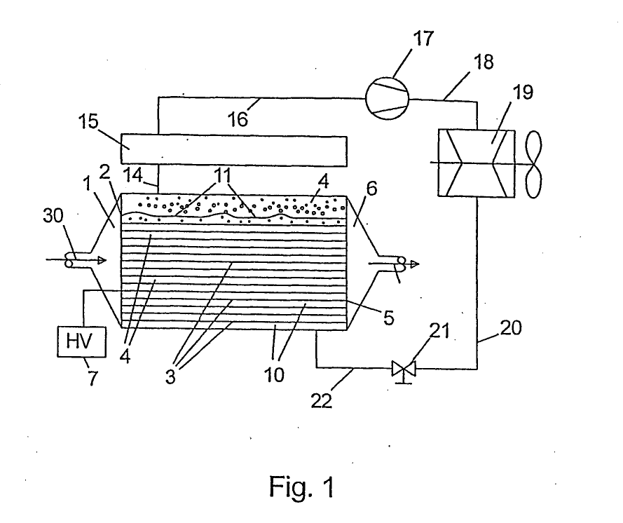

FIG. 1: is a block diagram of an ozone generator according to the invention with the associated cooling unit; and

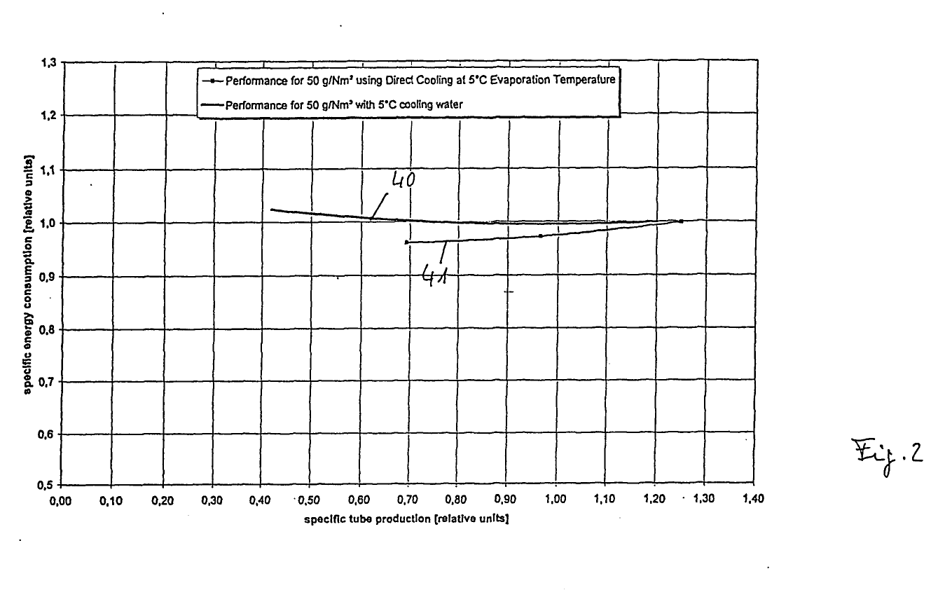

FIG. 2: is a diagram of the specific ozone generation per tube relative to the specific energy consumption in relative units when using air and a temperature of 5° C. for a conventional ozone generator and a directly cooled ozone generator.

FIG. 1 is a schematic side view of an ozone generator. The ozone generator comprises an inflow chamber 1, which is defined by a tubesheet 2. A plurality of hollow cathode tubes 3 have been inserted into the tubesheet 2 in such a way that the interior spaces of the hollow cathode tubes are connected to the inflow chamber 1, while a shell 4 surrounding the hollow cathode tubes 3 on the outside is hermetically sealed relative to the inflow chamber 1. At their opposite ends from the tubesheet 2, the hollow cathode tubes 3 are likewise connected hermetically with a second tubesheet 5, which in turn defines an outflow chamber 6. Inside the hollow cathode tubes 3 there are arranged anode rods or anode wires with dielectrics, not illustrated in FIG. 1, to which in turn a high voltage supply 7 is applied with the necessary operating voltage. Annular gaps are formed between the anodes and the hollow cathode tubes 3.

The shell 4 of the ozone generator is filled with a coolant 10. This coolant 10 is in a liquid state up to the surface 11, while above the surface 11 it is present in the form of vapor. The coolant 10 is circulated via a coolant circuit, which comprises a vapor line at the top of the ozone generator, extending from the shell space. The vapor line 14 leads into a phase separator 15, in which any aerosols contained in the vapor are separated therefrom. A further line 16 passes from there to a coolant compressor 17, which conveys the coolant still present in vapor form via a pressure line 18 under elevated pressure to a cooler 19. In the cooler 19, the compressed vapor is cooled, the thermal energy contained therein dissipated and the refrigerant thus liquefied. A pressure line 20 leads to a level control valve 21, which feeds the pressurized, liquid coolant back into the shell space 4. In the shell space 4, the coolant 11 absorbs the waste heat arising during ozone generation, evaporates and once again enters the coolant circuit via the lines 14-22.

The coolant 10 is in the boiling state in the shell 4, in which state the temperature is constant over the entire volume of liquid coolant, i.e. from the inlet point of the line 22 to the surface 11. This temperature corresponds to the boiling point of the coolant 10 under the prevailing conditions, which are defined solely by the pressure above the surface 11. The temperature of the entire liquid coolant volume in the shell 4 may be adjusted by means of the pressure above the surface 11. A temperature gradient along the hollow cathode tubes 3 does not arise.

The steel used to produce the ozone generator, more precisely to produce the electrode tubes 3, the tubesheets 2 and 5 and the housing, is a relatively low-alloy steel, with a nickel content of below 10 wt. % and/or a molybdenum content of below 2 wt. %. These steels are not resistant to the corrosion to be expected in water-cooled ozone generators, in particular that caused by chlorine ions, which induce pitting. They may nevertheless be used to construct directly cooled ozone generators.

In addition to the lower price, such steels, in particular ferritic chromium steels, make it possible to achieve particularly good heat transfer, since these steels exhibit approximately twice the level of heat conductivity exhibited by the conventionally used chromium-nickel steels. The efficiency of the ozone generator is therefore further increased since the heat is not only particularly evenly distributed but also particularly well dissipated. This further reduces the temperature-induced ozone degradation at high ozone concentrations.

Ferritic chromium steels with a chromium content of 10 to 17 wt. % are currently preferred as materials, for example the steels 1.4000 (X6Cr13), 1.4001 (X7Cr14), 1.4002 (X6CrAl13) or 1.4510 (X3CrTi17), which exhibit a heat conductivity of around 30 W/mK. The steel 1.4571 (X6CrNiMoTi17-12-2) used hitherto, on the other hand, exhibits a heat conductivity of only 15 W/mK. The steel designations used here correspond to the German steel classification.

In another embodiment, which is particularly suitable for large ozone generators, the shell 4 not exposed to ozone is made of normal steel, such as for example ST37. This has the advantage over the above-mentioned heat-conductive special steels of being markedly cheaper, thus enabling the costs of manufacturing the ozone generator to be reduced still further.

A further embodiment provides for a heat-conductive non-ferrous alloy, preferably an aluminum alloy, to be used to produce the electrode tubes 3, the tubesheets 2 and 5 and the shell 4. This has a heat conductivity of around 200 W/mK, which further improves the efficiency of the ozone generator.

In practice, it has been demonstrated that the uniform temperature distribution and the heat dissipation within the shell 4 take place significantly more efficiently when ozone is generated in an incoming gas stream 30 containing oxygen. The product ozone content in the outgoing gas stream 31 is higher than is achievable according to the prior art for the same energy input. On the other hand, for the same ozone concentration in the outgoing gas stream 31, total energy use is lower than with conventional apparatus.

This relationship between the ozone generators of the type discussed above and the water-cooled generators known from practical experience is clarified in FIG. 2. In this Figure, the specific tube output (for example in g/h) of a hollow cathode tube 3 is plotted in relative units on the x axis, relative to the specific energy consumption therefor (for example in kWh/kg) on the y axis, likewise in relative units. The continuous line 40 shows the specific energy consumption as a function of the tube output with air as the gaseous feedstock and a cooling water temperature of 5° C. in a conventional ozone generator which comprises a cooling water circuit and a downstream indirect cooling unit. The curve 41 therebelow with three measuring points indicated by rectangles shows the corresponding specific energy consumption for the same gaseous feedstock and the same product ozone concentration with an apparatus according to the invention at an evaporation temperature likewise of 5° C. It is clear that the energy consumption in the mid-zone of the specific tube output, at around 0.70, is approximately 5% less than with a conventional ozone generator. This advantage is noticeable in particular in the case of low specific tube outputs. The process was in each case controlled in such a way that an ozone concentration of 50 g/m³ air was generated under standard conditions. This advantage of directly cooled ozone generators known per se is further improved by selecting the materials proposed according to the invention.

This means in practice that, for the same specific energy consumption, the ozone generator may itself be made significantly still smaller. It is a question of economic viability whether preference is here given to lower energy consumption in operation or reduced investment costs due to the possibility of constructing a smaller ozone generator.

Economic advantages are provided by the possibility of making the plant components of a less corrosion-resistant material than is necessary when cooling water is used and than is known from the prior art.

Energy efficiency advantages are also obtained relative to the prior art even at evaporator temperatures of 15° C. In addition, the new materials make it possible to generate ozone concentrations which are markedly higher again than can be generated using conventional technology under comparable operating conditions.

1-10. (canceled)

11. An ozone generator, comprising:
a number of steel components including hollow cathode tubes, tubesheets, and a shell; wherein the hollow cathode tubes are disposed between oppositely disposed tubesheets, wherein each hollow cathode tube delimits an inner space through which gas may flow, wherein the hollow cathode tubes delimit a shell space that may be subjected to coolant, and wherein the steel components are made at least in part of a steel having a nickel content of less than 10% by weight and/or a molybdenum content of less than 2% by weight; and
a cooling unit provided for cooling and including an evaporator, compressor and condenser, wherein the evaporator is incorporated directly into the shell of the ozone generator.

12. An ozone generator according to claim 11, wherein the steel is a ferritic chromium steel having a chromium content of 10-17% by weight.

13. An ozone generator according to claim 11, wherein the steel is selected from the group of steels that have a heat conductivity of greater that 20 W/mK.

14. An ozone generator according to claim 11, wherein the steel is selected from the group consisting of the following steels: 1.400 (X6Cr13), 1.4001 (X7Cr14), 1.4002 (X6CrAl13), 1.4510 (X3CrTi17).

15. An ozone generator comprising:
a number of steel components including hollow cathode tubes, tubesheets, and a shell; wherein the hollow cathode tubes are disposed between oppositely disposed tubesheets, wherein each hollow cathode tube delimits an inner space through which gas may flow, wherein the hollow cathode tubes delimit a shell space that may be subjected to coolant, and wherein the shell is made of a normal steel; and
a cooling unit provided for cooling and including an evaporator, compressor and condenser, wherein the evaporator is incorporated directly into the shell of the ozone generator.

16. An ozone generator comprising:
a number of components including hollow cathode tubes, tubesheets, and a shell; wherein the hollow cathode tubes are disposed between oppositely disposed tubesheets, wherein each hollow cathode tube delimits an inner space through which gas may flow, wherein the hollow cathode tubes delimit a shell space that may be subjected to coolant, and wherein the components are made at least in part of an aluminum alloy,
a cooling unit provided for cooling and including an evaporator, compressor and condenser, wherein the evaporator is incorporated directly into the shell of the ozone generator.

17. An ozone generator according to claim 11, wherein the inner space and the shell space have a pressure resistance of at least 16 bar.

18. An ozone generator according to claim 11, wherein the coolant is 1,1,1,2-tetrafluoroethane (CF₃—CH₂F).

19. An ozone generator according to claim 11, wherein an aerosol separator is provided between the shell space and the compressor.

20. An ozone generator according to claim 11, wherein means are provided for controlling a pressure in the shell space.

21. An ozone generator according to claim 15, wherein the inner space and the shell space have a pressure resistance of at least 16 bar.

22. An ozone generator according to claim 15, wherein the coolant is 1,1,1,2-tetrafluoroethane (CF₃—CH₂F).

23. An ozone generator according to claim 15, wherein an aerosol separator is provided between the shell space and the compressor.

24. An ozone generator according to claim 15, wherein means are provided for controlling a pressure in the shell space.

25. An ozone generator according to claim 16, wherein the inner space and the shell space have a pressure resistance of at least 16 bar.

26. An ozone generator according to claim 16, wherein the coolant is 1,1,1,2-tetrafluoroethane (CF₃—CH₂F).

27. An ozone generator according to claim 16, wherein an aerosol separator is provided between the shell space and the compressor.

28. An ozone generator according to claim 16, wherein means are provided for controlling a pressure in the shell space.
